(19) United States
(12) Patent Application Publication
(10) Pub. No.: US 2014/0219755 A1
(43) Pub. Date: Aug. 7, 2014

(54) ACTUATING SYSTEM FOR EJECTOR OF DUMP TRUCK

(71) Applicant: Caterpillar SARL, Geneva (CH)

(72) Inventor: ADAM JOHNSON LAMBERT, DURHAM (GB)

(73) Assignee: Caterpillar SARL, Geneva (CH)

(21) Appl. No.: 14/251,597

(22) Filed: Apr. 12, 2014

(51) Int. Cl. B60P 1/36

(52) U.S. Cl. CPC B60P 1/365
USPC 414/516

(57) ABSTRACT

An actuating system for an ejector of a dump truck is disclosed herein. The dump truck includes a load carrying container having a first end and a second end. The actuating system includes a fluid cylinder, a first pulley, a second pulley, a third pulley, a first belt, and a second belt. The first pulley coupled to a second end of the fluid cylinder. The first belt coupled to the ejector blade at one end and coupled to the second pulley at the other end. The first belt passes over the first pulley and the second pulley to pulls the ejector blade in a first direction as the fluid cylinder extends. Similarly, the second belt passes over the first pulley and the third pulley to pull the ejector blade in a second direction as the fluid cylinder retracts.

### TECHNICAL FIELD

The present disclosure relates generally to dump trucks. More specifically, the present disclosure relates to an actuating system for an ejector of a dump truck.

### BACKGROUND

Dump trucks are used for transport of material from one place to another. One such use may include transport of construction material from an extraction site to a work-site. A dump truck generally includes a load carrying container, which holds the material. The dump truck may discharge the material by tilting the load carrying container and using gravitational forces for ejection of material. There may be conditions when the raising of the load carrying container may be obstructed, such as the presence of power lines or a low bridge below the work site. This may lead to incomplete ejection of the material. Alternatively, the dump truck with a pushed ejector blade system is used to dump to carry and dump material. Generally, the load carrying container is not tilted to eject the material in such dump trucks. The material may be ejected by pushing the material using the pushed ejector blade system.

The pushed ejector blade system includes an ejector blade, which is pushed to eject material from the load carrying container. In existing solutions, the ejector blade may be pushed using a multi-part telescoping fluid cylinder. The multi-part fluid cylinder may be expensive to manufacture, operate and maintain. In addition, the multi-part fluid cylinder has various parts in operation, which may require frequent alignment and maintenance.

### SUMMARY OF THE DISCLOSURE

One aspect of the present disclosure is directed to an actuation system for an ejector blade of a dump truck. The dump truck includes a load carrying container having a first end and a second end. The ejector blade is configured to move inside the load carrying container between the first end and second end. The actuating system includes a fluid cylinder, a first pulley, a second pulley, a third pulley, a first belt, and a second belt. The fluid cylinder includes a first end and a second end. The first end of the fluid cylinder is coupled to the load carrying container. The first pulley is coupled to the second end of the fluid cylinder. The second pulley is coupled proximal to the second end of the load carrying container. The third pulley is coupled proximal to the first end of the load carrying container. The first belt is coupled to the ejector blade at one end and coupled to the second pulley at the other end. The first belt passes over the first pulley and the second pulley. The first belt moves the ejector blade in a first direction as the fluid cylinder extends. The second belt is coupled to the ejector blade at one end and coupled to the third pulley at the other end. The second belt passes over the first pulley and the third pulley. The second belt moves the ejector blade in a second direction as the fluid cylinder retracts.

### BRIEF DESCRIPTION OF DRAWINGS

FIG. 1 illustrates a side view of an exemplary dump truck, in accordance with the concepts of the present disclosure;

FIG. 2 illustrates a rear view of a load carrying container, in accordance with the concepts of the present disclosure;

FIG. 3 illustrates an enlarged side view of a portion of the load carrying container showing an actuating system, in accordance with the concepts of the present disclosure; and

FIG. 4 illustrates an enlarged side view of the portion of the load carrying container showing the actuating system, in accordance with the concepts of the present disclosure.

### DETAILED DESCRIPTION OF DRAWINGS

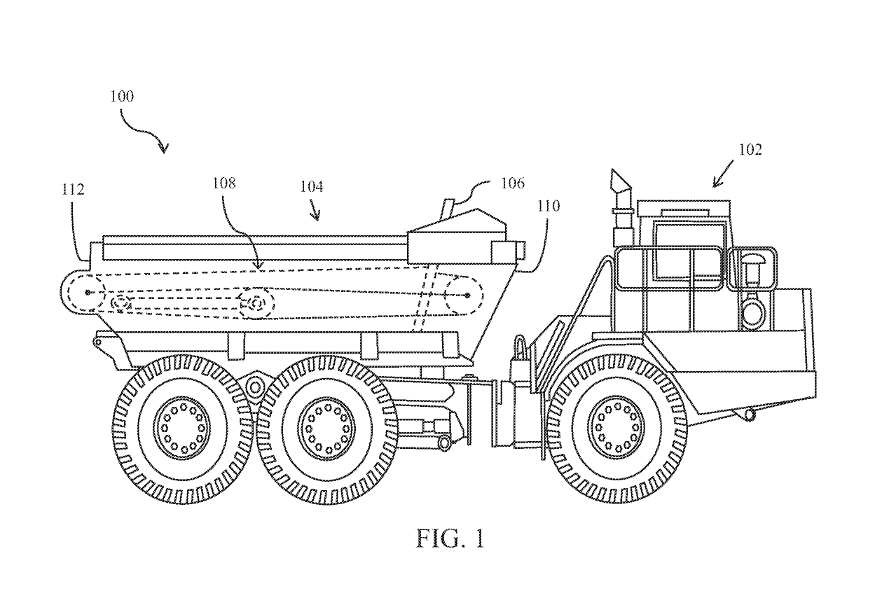

FIG. 1 illustrates a side view of an exemplary dump truck 100, in accordance with the concepts of the present disclosure. In reference to FIG. 1, the dump truck 100 may include a tractor unit 102, a load carrying container 104, an ejector blade 106, and an actuating system 108.

The tractor unit 102 is a part of the dump truck 100, which provides an actuating force for running the dump truck 100. The tractor unit 102 may include an engine and several other mechanisms that work in conjunction to generate the power required to run the dump truck 100. The tractor unit 102 may be pivotally coupled to the load carrying container 104. During running conditions, the tractor unit 102, pivotally coupled with the load carrying container 104, may provide a pulling force to the load carrying container 104. Therefore, the tractor unit 102 and the load carrying container 104 may move together during normal operation of the dump truck 100.

The load carrying container 104 is used for carrying a load material, such as sand material, asphalt material, or the like. The load carrying container 104 is configured to carry the load material from one place and dump it to another place. As an example, the load carrying container 104 may carry construction material from an extraction site and dump it at a work site. The load carrying container 104 includes a first end 110, which is proximal to the tractor unit 102, and a second end 112, which is distal to the tractor unit 102. The load carrying container 104 may dump the material at the work-site using the ejector blade 106. The ejector blade 106 is configured to move inside the load carrying container 104 between the first end 110 and the second end 112 of the load carrying container 104. As the ejector blade 106 moves between the first end 110 and the second end 112 of the load carrying container 104, the material is ejected through a movable tailgate at the second end 112. The ejector blade 106 is moved inside the load carrying container 104 by the actuating system 108.

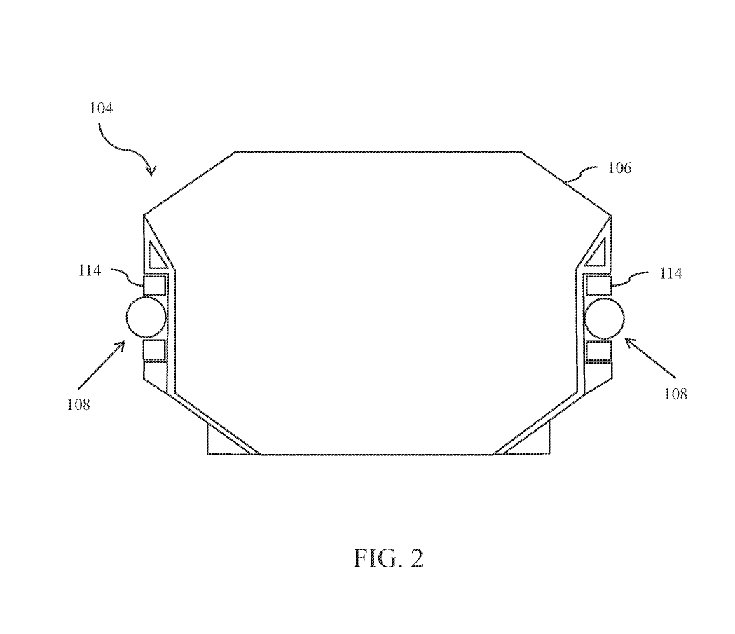

FIG. 2 illustrates a rear view of the load carrying container 104, in accordance with the concepts of the present disclosure. FIG. 2 is described in conjunction with the elements from FIG. 1. The actuating system 108 may be installed on the sidewalls of the load carrying container 104. The actuating system 108 is configured to move the ejector blade 106 to eject material from the load carrying container 104. In an embodiment, there may be two actuating systems 108 installed on the two sidewalls of the load carrying container 104. The actuating system 108 may be coupled to the ejector blade 106 at a blade carriage 114. The actuating system 108 may move the ejector blade 106 by pulling the ejector blade 106 along the blade carriage 114.

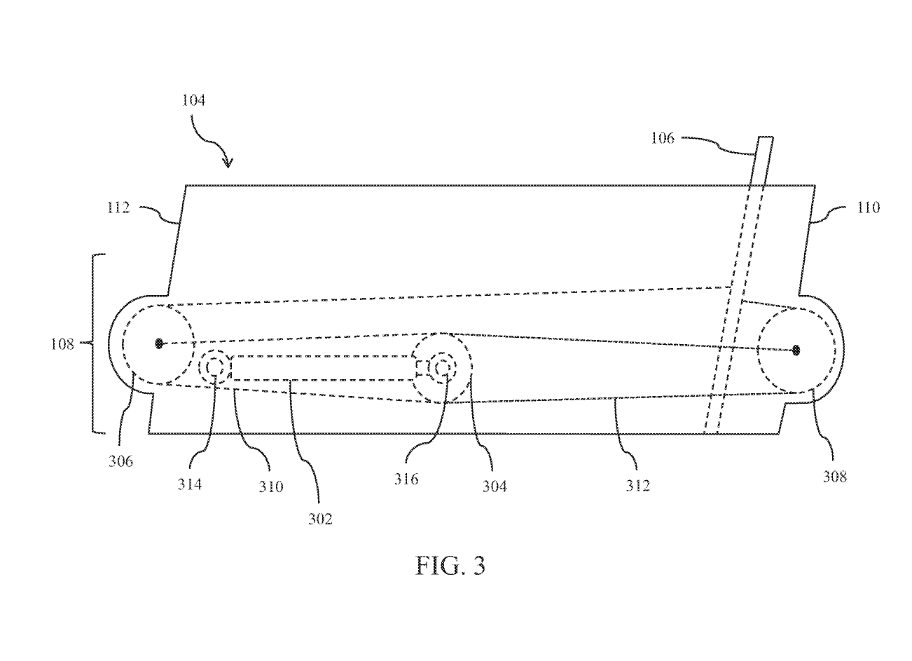

FIG. 3 illustrates an enlarged side view of a portion of the load carrying container 104 showing the actuating system 108, in accordance with the concepts of the present disclosure. FIG. 3 is described in conjunction with the elements from FIG. 1 and FIG. 2. In reference to FIG. 3, the actuating system 108 may include a fluid cylinder 302, a first pulley 304, a second pulley 306, a third pulley 308, a first belt 310, and a second belt 312.

The fluid cylinder 302, such as but not limited to, a hydraulic cylinder, a pneumatic cylinder, and the like is configured to extend and retract. The fluid cylinder 302 includes a first end 314 and a second end 316. The first end 314 of the fluid cylinder 302 is coupled with the load carrying container 104. In an embodiment (as shown in the FIG), the first end 314 of the fluid cylinder 302 is coupled at the second end 112 of the load carrying container 104. Further, the fluid cylinder 302 may be coupled to the sidewalls of the load carrying container 104 using a plurality of support brackets, thereby supporting the fluid cylinder 302 in a horizontal orientation. The second end 316 of the fluid cylinder 302 is coupled to the first pulley 304. The second pulley 306 and the third pulley 308 are mounted on the sidewalls of the load carrying container 104. The second pulley 306 is coupled proximal to the second end 112 of the load carrying container 104. The third pulley 308 is coupled proximal to the first end 110 of the load carrying container 104. The first belt 310 is coupled to the ejector blade 106 at one end and coupled to the second pulley 306 at the other end. The first belt 310 may be, such as but not limited to, a rope, a chain or an equivalent thereof. The first belt 310 passes over the first pulley 304 and the second pulley 306. The first belt 310 moves the ejector blade 106 in a first direction as the fluid cylinder 302 extends. The second belt 312 is coupled to the ejector blade 106 at one end and coupled to the third pulley 308 at the other end. The second belt 312 may be, such as but not limited to, a rope, a chain or an equivalent thereof. The second belt 312 passes over the first pulley 304 and the third pulley 308. The second belt 312 moves the ejector blade 106 in a second direction as the fluid cylinder 302 retracts. Therefore, the actuating system 108 moves the ejector blade 106 in the first direction and the second direction. The ejector blade 106 is proximal to the first end 110 of the load carrying container 104, when the fluid cylinder 302 is in retracted position as shown in FIG. 3.

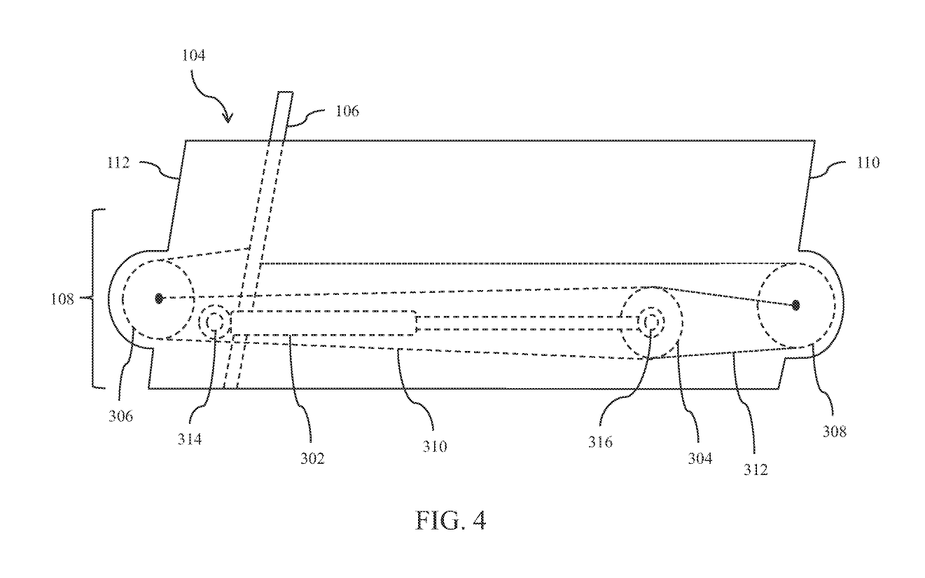

FIG. 4 illustrates an enlarged side view of the portion of the load carrying container 104 showing the actuating system 108, in accordance with the concepts of the present disclosure. FIG. 4 is explained in conjunction with the elements of FIG. 1, FIG. 2, and FIG. 3. In reference to FIG. 4, an extended position of the fluid cylinder 302 is shown. The ejector blade 106 is proximal to the second end 112 of the load carrying container 104, when the fluid cylinder 302 is in extended position

In an embodiment, the first pulley 304, the second pulley 306, and the first belt 310 may work in conjunction to pull the ejector blade 106 in the first direction, from the first end 110 to the second end 112 of the load carrying container 104. The first pulley 304, the second pulley 306, and the first belt 310 work on the reverse block and tackle principle. As the fluid cylinder 302 extends, it pushes the first pulley 304 along with it. As, the first pulley 304 moves a certain distance, the first belt 310 pulls the ejector blade 106 in the first direction, from the first end 110 to the second end 112. The travel of the ejector blade 106 in the first direction may cause the ejection of the material carried by the load carrying container 104. In adherence to the reverse block and tackle principle, the first belt 310 pulls the ejector blade 106 twice the distance moved by the first pulley 304. In other words, the ejector blade 106 travels twice the amount of extension of the fluid cylinder 302. Also, the first belt 310, the first pulley 304, and the second pulley 306 work in conjunction following the reverse block and tackle principle, to pull the ejector blade 106.

Furthermore, the first pulley 304, the third pulley 308, and the second belt 312, work in conjunction to pull the ejector blade 106 in a second direction, from the second end 112 to the first end 110. As the fluid cylinder 302 retracts, it pulls the first pulley 304 towards itself. As, the first pulley 304 moves a certain distance, the second belt 312 pulls the ejector blade 106 in the second direction, from the second end 112 to the first end 110 of the load carrying container 104. In adherence to the reverse block and tackle principle, the second belt 312 pulls the ejector blade 106 twice the distance moved by the first pulley 304. In other words, the ejector blade 106 travels twice the amount of retraction of the fluid cylinder 302.

### INDUSTRIAL APPLICABILITY

In operation, the dump truck 100 carries the material from one place to another. The dump truck 100 is configured dump the material carried by the load carrying container 104. The ejector blade 106 is in first position proximal to the first end 110 of the load carrying container 104 when the fluid cylinder 302 is in retracted position as shown in FIG. 3. Whereas, the ejector blade 106 is in second position proximal to the second end 112 of the load carrying container 104 when the fluid cylinder 302 is in extended position as shown in FIG. 4. When, it is required to dump the material carried by the load carrying container 104, an operator may activate the actuating system 108. As the actuating system 108 is activated, a fluid may flow through the fluid cylinder 302, thereby extending the fluid cylinder 302. As the second end 316 of the fluid cylinder 302 is coupled to the first pulley 304, it causes the movement of the first pulley 304 as well. The first pulley 304 causes a pulling force in the first belt 310. As the first belt 310 is connected to the ejector blade 106, the pulling force in the first belt 310 causes the ejector blade 106 to move in the first direction. The movement of the ejector blade 106 in the first direction may cause the ejection of the material carried by the load carrying container 104.

Further, the ejector blade 106 may need to be pulled back to repeat the same process at a later time from the second position to the first position. In that case, the operator may de-activate the actuating system 108. As the actuating system 108 is de-activated, the fluid in the fluid cylinder 302 may flow back to a reservoir, thereby refracting the fluid cylinder 302. As, the second end 316 of the fluid cylinder 302 is coupled to the first pulley 304, it causes the movement of the first pulley 304 towards itself. The movement of the first pulley 304 may cause a pulling force in the second belt 312. As the second belt 312 is connected to the ejector blade 106, the pulling force in the second belt 312 causes the ejector blade 106 to move in the second direction.

Thus, the present disclosure provides the actuating system 108 for the ejection of material carried by the load carrying container 104. The actuating system 108 as described in the present disclosure may require lesser amount of extension and/or refraction of the fluid cylinder 302. Therefore, the actuating system 108 as described in the present disclosure may be less expensive to operate. As the actuating system 108 requires lesser amount of extension and/or retraction of the fluid cylinder 302, a single stage fluid cylinder 302 may be effective to serve the purpose. The single stage fluid cylinder 302 may have a smaller number of parts that work in conjunction, the misalignment may be of less concern. Therefore, the actuating system 108 may be cheaper to operate, maintain, and install.

It should be understood that the above description is intended for illustrative purposes only and is not intended to limit the scope of the present disclosure in any way. Thus, those skilled in the art will appreciate that other aspects of the disclosure can be obtained from a study of the drawings, the disclosure, and the appended claim.

What is claimed is:

1. An actuation system for an ejector blade of a dump truck, the dump truck comprising a load carrying container having a first end and a second end, wherein the ejector blade is configured to move inside the load carrying container between the first end and second end, the actuation system comprising:
a fluid cylinder having a first end a second end, wherein the first end is coupled to the load carrying container;
a first pulley coupled with the second end of the fluid cylinder;
a second pulley coupled proximal to the second end of the load carrying container;
a third pulley coupled proximal to the first end of the load carrying container;
a first belt coupled to the ejector blade at one end and coupled to the second pulley at the other end, the first belt passes over the first pulley and the second pulley, the first belt moves the ejector blade in a first direction as the fluid cylinder extends; and
a second belt coupled to the ejector blade at one end and coupled to the third pulley at the other end, the second belt passes over the first pulley and the third pulley, the second belt moves the ejector blade in a second direction as the fluid cylinder retracts.
